(19) United States
(12) Patent Application Publication
(10) Pub. No.: US 2008/0057917 A1
(43) Pub. Date: Mar. 6, 2008

(54) SERVICE AVAILABILITY UPDATE FOR A USER HAVING A PREPAID ACCOUNT AT A SERVICE PROVIDER CAPABLE OF PROVIDING ONE OR MORE SERVICES OVER A COMMUNICATIONS NETWORK

(76) Inventor: Daniela Oria, Vantaa (IT)

Correspondence Address: PERMAN & GREEN, 425 POST ROAD, FAIRFIELD, CT, 06824, US

(21) Appl. No.: 11/468,559

(22) Filed: Aug. 30, 2006

(51) Int. Cl. H04Q 7/38

(52) U.S. Cl. 455/414.1

(57) ABSTRACT

A method of operating an apparatus enabled for usage by a user having a prepaid account at a service provider capable of providing one or more services over a communications network. The method involves retrieving credit status information about the prepaid account. At least for one service provided by the service provider, the credit status information is processed to determine a current availability of the one service. Then, a user interface of the apparatus is controlled to indicate the determined availability of the one service.

### FIELD OF THE INVENTION

The disclosed embodiments relate to service availability update for a user having a prepaid account at a service provider capable of providing one or more services over a communications network. In particular, the invention relates to a method, apparatus, system and computer program product for such service availability determination.

### BACKGROUND OF THE INVENTION

Users of various apparatuses may avail themselves of various services provided by different service providers over different communication networks. Non-limiting examples of such apparatuses and services include a digital music player (where the service may involve, for instance, downloading or streaming of digital music files like MP3, WMA or AAC files); a digital video player (where the service may involve, for instance, downloading or streaming of digital video files containing e.g. movies, sport events, music videos, etc); a gaming device (where the service may pertain to the installation of a new game, or participating in an online game); a digital television receiver (reception of digital TV transmissions over e.g. the Internet or a mobile telecommunications network); a navigating device (involving for instance map/route services); and a computer (miscellaneous services, including for instance WLAN access, file download, Internet browsing).

Still an example—which will be used in the following sections of this document—is a mobile terminal like a mobile (cellular) telephone or a personal digital assistant (PDA) for a telecommunications system like GSM, UMTS, D-AMPS, CDMA2000, FOMA or TD-SCDMA.

In many countries, prepaid accounts are widely used and are even, particularly for private users, believed to be the most common way of paying for mobile telecommunication services in certain countries. A person that holds a prepaid account at a service provider, such as an operator of a mobile telecommunications network, may use different telecommunication services where, of course, normal voice call is usually still the most frequently used. Other popular telecommunication services include SMS (Short Messages Services), MMS (Multimedia Messages Services), and mobile browsing (i.e. browsing html (hyper-text markup language) or wml (wireless markup language) coded web pages available over the Internet). From the operator's perspective, a prepaid account may be linked either directly to a certain user, or to a SIM (Subscriber Identity Module) card. In the latter case, which is often referred to as “prepaid card” (or “cash card”), the association between the prepaid account and the user may be indirect by way of the user's possession of the SIM card. In fact, the actual identity of the user need not necessarily be known by the operator in this case.

Prepaid cards are often considered a practical way of keeping the mobile telecommunication costs under control. A typical case in this respect is that of teenagers, who might get one prepaid card a month from their parents and therefore will have to manage their voice call/SMS/MMS/mobile browsing traffic to make the prepaid credit last for the whole month.

From this follows that for prepaid card users, and other kind of prepaid account users, it is both desirable and important to know the current balance of their prepaid account.

In the prior art, one common way of knowing how much credit is left on a prepaid card is calling a toll-free number and getting the desired information after interacting with an IVR (Interactive Voice Recognition) system.

It is also common in the prior art, when the credit is close to expiring (i.e., the current account balance approaches zero), for the network operator to push a message to the user's mobile terminal, for instance in the form of an SMS message having a message text that tells about the account shortage.

While these approaches of the prior art provide some degree of usefulness to a prepaid account user of an apparatus such as a mobile terminal, they nevertheless has a shortcoming in that they fail to provide the user with a clear and up-to-date picture not only of his current account balance but also what he can still do with it in terms of usage of different services. In the prior art, if the user wants to obtain the latter, he must look at the current account balance and estimate how much service it will allow him to use by considering the relevant prices of the different services provided by the service provider (e.g. network operator). In order to do this, he must have some sort of price list awareness, either physically by accessing e.g. a printed price list, or mentally if he can (correctly) remember the relevant prices.

### SUMMARY OF THE INVENTION

The disclosed embodiments aim at providing service availability update for an apparatus user, which holds a prepaid account, so that the user, at a given moment, will get an informative and easy-to-use overview of not just simply what his current account balance is, but more importantly what he can do with it in terms of possible usage of one or more services provided by a service provider.

Generally, the above objectives are achieved by a method, apparatus, system and computer program product according to the attached independent patent claims.

In a first aspect a method of operating an apparatus enabled for usage by a user having a prepaid account at a service provider capable of providing one or more services over a communications network is provided. In one embodiment, a method comprises:
retrieving credit status information about the prepaid account;
at least for one service provided by said service provider, processing said credit status information to determine a current availability of said one service; and

controlling a user interface of said apparatus to indicate the determined availability of said one service.

The credit status information about the prepaid account may be retrieved by receiving it from a network resource of said service provider over said communications network. To this end, the first aspect may involve an initial step, prior to receiving credit status information, of sending a request for credit status information from said apparatus to said network resource.

Furthermore, for increased convenience of the user, the apparatus may be configured to perform the method, starting with the initial step of sending the request for credit status information, repeatedly in accordance with a predefined service availability update scheme. Thus, the apparatus may be configured to initiate a service availability update by sending the request for credit status information, such that the step of receiving, and the steps following this, will be performed in an active pull manner rather than a passive push manner. For instance, such predefined scheme may be to perform the service availability update each time the apparatus is powered on, or at a time-based periodicity (e.g. once every n minutes, hours, days, etc), or after each performance or usage of a service.

The apparatus referred to above may, for instance, be selected from the group consisting of a mobile terminal, a personal digital assistant (PDA), a digital music player, a digital video player, a gaming device, a digital television receiver, a navigating device, and a computer. The apparatus will typically have a network interface suitable for communication with the service provider over the communications network. The network interface may for instance be a wireless interface to a mobile telecommunications network, a wireless or wire-based interface to a packet-switched data communications network, or a wireless or wire-based telephone interface to a public switched telephone network.

For embodiments where the apparatus is a mobile terminal in the form of, for instance, a mobile (cellular) telephone or a PDA for a mobile telecommunication system like GSM, UMTS, D-AMPS, CDMA2000, FOMA or TD-SCDMA, said service provider may be an operator of a mobile telecommunications network, and said one or more services may be one or more telecommunication services to be performed over said mobile telecommunications network.

For such embodiments, processing said credit status information may involve determining a current availability of a first telecommunication service and a current availability of a second telecommunication service provided by said mobile telecommunications network operator, and controlling the user interface of said apparatus may involve indicating the determined availability of at least one of said first and second telecommunication services.

Therefore, for such embodiments, the first aspect of the invention can be described as functionality that provides a user of a mobile terminal with service availability update based on credit status information from the operator, such that the user, at a given moment, will get an up-to-date overview of not just simply what the balance of his prepaid account currently is, but more importantly what he can do with it in terms of possible usage of different telecommunications services.

Typically, the first telecommunication service and the second telecommunication service are different services in the group consisting of: SMS messages, MMS message, email messages, voice calls, local voice calls, national voice calls, international voice calls, voice calls to subscribers belonging to the operator of said mobile telecommunications network, voice calls to subscribers belonging to another operator than said operator, data calls, fax transmissions, and packet-switched data communication (such as communication of wap data, http data, or Voice over IP (VoIP) data in e.g. Internet Protocol (IP) packets).

The credit status information may be communicated over any available channel in the mobile telecommunications network, for instance included in an electronic message (like SMS, MMS or email), or by way of packet-switched data communication, or as part of system control data exchanged between the network and mobile terminal at system access, paging, etc.

Advantageously, controlling the user interface may involve presenting the determined availability of said one service on a display of the apparatus. Therefore, at least for the embodiments referred to above where the apparatus is a mobile terminal, the determined availability may be presented as plain informative text (e.g. “Voice calls available”, “SMS available”, “NMS unavailable”). Depending on implementation, the availability of both of the first and second telecommunication services may be presented at the same time, or one after the other, or just one of them that is of momentary interest (advantageously as specified by the user). Alternatively, the determined availability may for instance be presented in the form of symbolic graphical icons on the display.

Said credit status information conveniently includes a current balance of said account. Processing said credit status information may thus involve determining, whether the current balance is at least equal to a lowest cost for using said one service, and controlling the user interface may involve presenting said one service as available, if the current balance has been determined to be at least equal to said lowest cost, and, otherwise, refraining from presenting said one service as available.

Thus, in this embodiment, a service is presented as available if it has been found during the processing that the current balance permits at least one one-time or minimum-duration usage of the service in question (such as a one-time transmission of a electronic message such as SMS or MMS, or a shortest possible voice call with the connection cost (startup cost) included.

Moreover, presenting said one service as available may involve presenting a user interface item on said display as currently selectable, whereas refraining from presenting said one service as available may involve presenting said user interface item on said display as currently non-selectable.

Such user interface items may for instance be selectable (enabled) and non-selectable (disabled) menu items in a menu list, or icons, control buttons, check boxes, etc. At least for the embodiments referred to above where the apparatus is a mobile terminal, using selectable/non-selectable user interface items in this manner to indicate the current availability of at least said one of said first and second telecommunication services for a user of the mobile terminal (i.e. to indicate whether the or each service is available or unavailable in view of the current balance of the user's prepaid account) is beneficial, since it will allow further functionality upon selection by the user of the user interface item when selectable.

For instance, if the user interface item is a menu item in a menu list, the selection thereof may trigger presentation of service availability information on a more detailed level. If, for example, the selectable menu item indicates current availability of SMS service, such more detailed service availability information may be the number of SMS messages that can be sent with the current balance of the prepaid account.

As another example, related information may be compiled and presented upon selection of the user interface item. For voice call services by different network operators (typically with different rates and charges), such related information may be a list of all contact members in the terminal's Phonebook which belong to a certain network operator.

Alternatively, refraining from presenting said one service as available may plainly mean doing nothing; i.e. if the service is found to be available (since the current balance was found to cover the lowest cost for using the service), a presentation to this effect is done on the display, but if it on the other hand is found to be unavailable (because of a shortage in the current balance), no presentation is done. In other words, according to this alternative, only services that have been positively found to be available will be indicated by presenting associated information to this effect on the display, and the absence of such information therefore means that the associated service is currently unavailable.

In one or more embodiments, aforesaid lowest cost for using said one service is derived from service price data received from said network resource. Thus, the lowest cost may be represented by certain data in the credit status information, in addition to data that represents the account balance as such.

Alternatively, aforesaid lowest cost for using said one service may be derived from service price data stored in local memory in or associated with said apparatus. Therefore, with this alternative, the lowest cost may be represented in or by reference data in the form of service price data which has been stored in advance in local memory. Such reference data may be inserted and/or updated manually by the user by way of a dedicated function in the user interface, which for instance allows the user to change a setting in a control panel application. Alternatively, the locally stored reference data may be updated automatically at some periodicity by way of certain functionality which receives the updated service price data over an available channel (such as in an electronic message, or as wml/html data pushed or pulled from a remote wap/http (wireless application protocol/hyper-text transfer protocol) server to the apparatus).

In a more sophisticated embodiment, where said credit status information again includes a current balance of said account,
processing said credit status information involves determining, based on said current balance and a usage cost for using said one service, an extent of available usage for said one service, and
controlling the user interface involves presenting the extent of available usage for said one service.

By “extent of available usage for said one service” is meant any quantitative measure of the extent to which said one service may be used by said user, given the current balance and the usage cost. For instance, when the service is SMS messaging, the usage cost may be the cost charged by the operator for transmitting one SMS message, and the extent of available usage of SMS messaging is thus an indication how many SMS messages that may be sent spending the current balance.

When the service is voice call, the usage cost may for instance be the minute rate plus any fixed connection (start-up) cost, as is typically charged by telecom operators when it comes to voice calls. The extent of available usage for voice calls may thus be an indication of the maximum duration of one voice call spending the current balance. Alternatively, the extent of available usage for voice calls may be an estimation of how many voice calls that may be financed by the current balance, assuming that each call will have a typical average duration. Such average duration may be monitored over time by the mobile terminal, so as to provide a true estimation given the particular user's typical usage pattern of voice calls.

As has already been described for the aforesaid lowest cost, the usage cost may either be received as service price data in the credit status information from the network resource, in addition to data that represents the balance as such, or it may be represented in or by certain reference data which has been stored in advance in local memory.

In one embodiment, where again said credit status information includes a current balance of said account,
processing said credit status information involves determining whether the current balance at least meets a threshold cost value (which may be a lowest cost for using said one service),
wherein, if the current balance has been determined not to meet said threshold cost value, controlling the user interface involves:
prompting the user to input purchasing details (such as credit card data, bank account data, and/or personal identification data), and
transmitting the purchasing details thus input to a network resource of said service provider so as to request purchase of additional credit (for instance by placing a system call or sending an electronic message).

This embodiment thus provides a semi-automatic way of increasing the credit balance by detecting insufficient credit status in the apparatus and facilitating for the user to purchase additional credit.

A second aspect of the invention is the apparatus which has already been referred to above, i.e. an apparatus enabled for usage by a user having a prepaid account at a service provider capable of providing one or more services over a communications network, the apparatus comprising:
a processing device; and
a user interface,
wherein the processing device is configured to:
retrieve credit status information about the prepaid account;
at least for one service provided by said service provider, process said credit status information to determine a current availability of said one service; and
control the user interface to indicate the determined availability of said one service.

The second aspect may generally have the same objectives and advantages, and the same or directly corresponding features, as the first aspect.

The processing device may be a CPU (Central Processing Unit), DSP (Digital Signal Processor) or any other electronic programmable and/or logic device or combination of devices.

A third aspect of the invention is a computer program product comprising machine-readable instructions which, when executed by a processing device, perform the steps of the method according to the first aspect.

A fourth aspect of the invention is a system comprising:
a network resource of a service provider capable of providing one or more services over a communications network; and
an apparatus enabled for usage by a user having a prepaid account at said service provider, the apparatus comprising a processing device and a user interface, wherein the processing device is configured to:
receive credit status information about the prepaid account from said network resource;
at least for one service provided by said service provider, process said credit status information to determine a current availability of said one service, and
control the user interface to indicate the determined availability of said one service.

A fifth aspect of the invention is an apparatus enabled for usage by a user having a prepaid account at a service provider capable of providing one or more services over a communications network, the apparatus comprising:
means for retrieving credit status information about the prepaid account;
means for processing said credit status information to determine a current availability of at least one service provided by said service provider; and
means for controlling a user interface to indicate the determined availability of said one service.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The disclosed embodiments will now be described in more detail, reference being made to the enclosed drawings, in which:

FIG. 1 is a schematic illustration of a telecommunication system, including a mobile terminal and a network resource held by an operator of a mobile telecommunications network, as an example of an environment in which the present invention may be applied.

FIG. 2 is a schematic block diagram illustrating a mobile terminal according to one embodiment.

FIG. 3 is a flow chart which illustrates a method, in a mobile terminal, of providing service availability update according to one embodiment.

FIGS. 4a-4e are schematic display screen snapshots which are shown in sequence to a user of a mobile terminal when using the method according to one embodiment.

### DETAILED DESCRIPTION OF THE EMBODIMENTS

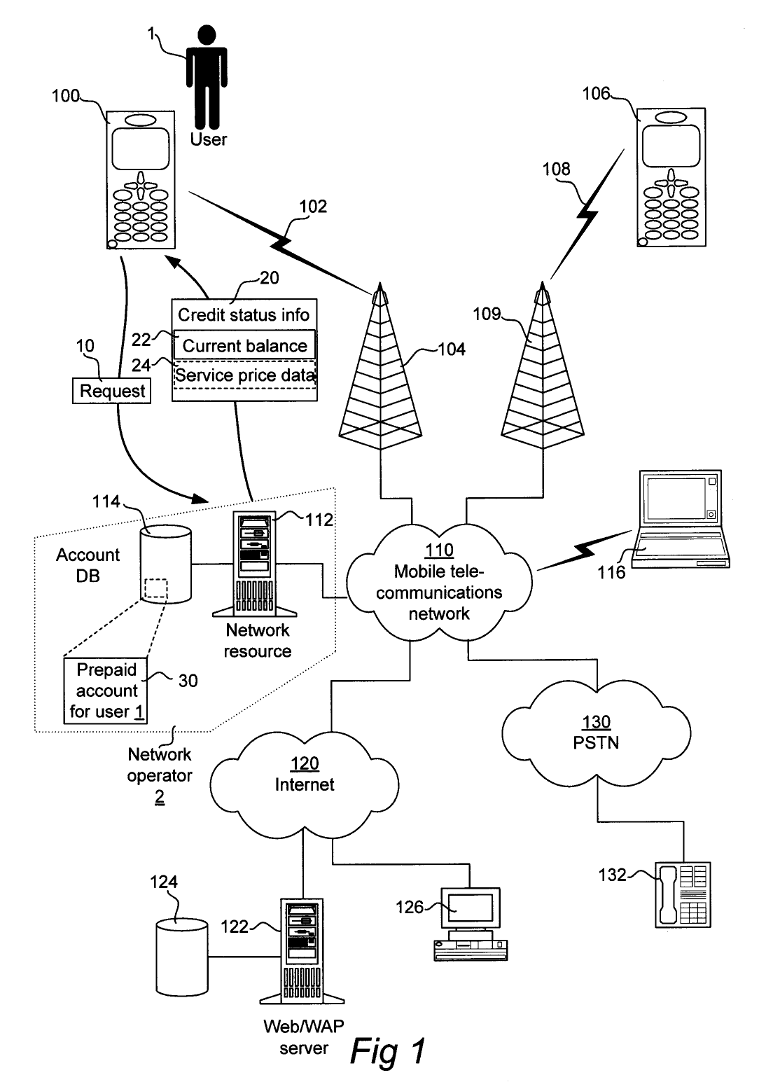

FIG. 1 illustrates one example of a telecommunications system in which the invention may be applied. In the telecommunication system of FIG. 1, various telecommunication services such as voice calls, data calls, facsimile transmissions, music transmissions, still image transmissions, video transmissions, electronic message transmissions, mobile browsing and electronic commerce may be performed to and/or from different mobile terminals 100, 106 or other portable devices 116. At least some of these services may be used by a user 1 of the mobile terminal 100 and be debited against a prepaid account 30 that the user 1 holds at a network operator 2. Therefore, the mobile terminal 100 is one example of an apparatus according to the invention. As already explained in a previous section of this document, the invention is however also applicable to other apparatuses than mobile terminals, including but not limited to digital music players, digital video players, gaming devices, digital television receivers, navigating devices, and computers, and consequently to other service providers than operators of mobile telecommunications networks.

The mobile terminals 100, 106 are connected to a mobile telecommunications network 110, held by the network operator 2, through RF links 102 and 108 via respective base stations 104, 109. The mobile telecommunications network 110 may be any commercially available mobile telecommunications system, including but not limited to GSM, UMTS, D-AMPS, CDMA2000, FOMA or TD-SCDMA, or any combination of such systems. The mobile terminals 100, 106 are illustrated as mobile (cellular) telephones but may alternatively be other kinds of portable devices, such as personal digital assistants or communicators, as mentioned above.

A public switched telephone network (PSTN) 130 is connected to the mobile telecommunications network 110 in a familiar manner. Various telephone terminals 132 are connected to the PSTN 130.

The mobile telecommunications network 110 is operatively connected to a wide area network 120, which may be Internet or a part thereof. Various web/wap servers 122 may make contents 124 available for client computers 126 connected to the wide area network 120, and for the mobile terminals 100, 106.

The network operator 2 has a network resource 112 in the form of e.g. a server computer or computer system with an associated account database 114. The account database 114 stores the prepaid account 30 of the user 1, as well as a large number of other accounts, which may be prepaid accounts or conventional subscription accounts with post-payment (i.e. accounts the owners of which will be billed after service usage at some periodicity).

The network resource 112, or other equipment of the network operator 2, has debiting functionality which monitors service usage by the user 1 and charges his prepaid account 30 accordingly. Moreover, the network resource also has functionality for sending credit status information 20 to the mobile terminal 100 over the mobile telecommunications network 110 on an available channel. For instance, the credit status information 20 may be included in an SMS sent to the mobile terminal 100 from the network resource 112, or the credit status information may be sent as packet-switched data, or it may be appropriately included in system control data exchanged between the network 110 and mobile terminal 100 at system access, paging, etc. In some embodiments, the credit status information 20 is pulled by the mobile terminal 100 by sending a request 10 to the network operator 2, which upon receipt thereof may initiate sending of the credit status information 20 by the network resource 112.

The credit status information 20 will be used in the mobile terminal 100 provide service availability update functionality according to the invention for the prepaid account user 1, as will be described in more detail later. The credit status information 20 may be temporarily received and stored in local memory of the mobile terminal 100 one beforehand; it need not be received in direct conjunction with the performance of the service availability update functionality.

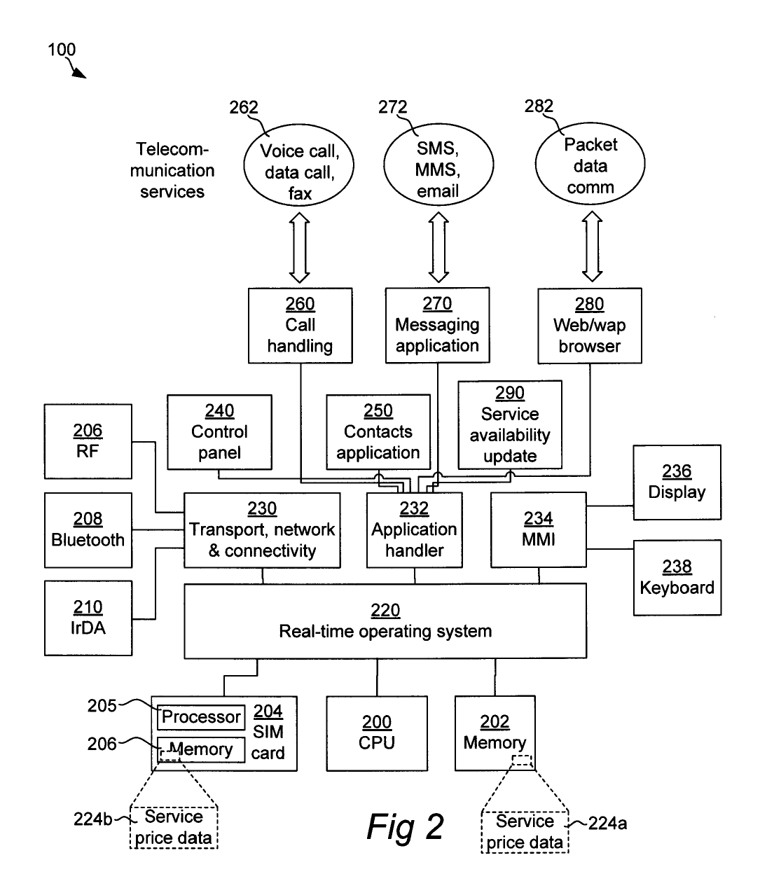

As seen in FIG. 2, the mobile terminal 100 has a processing device in the form of a controller 200 which is responsible for the overall operation of the mobile terminal and is preferably implemented by any commercially available CPU (Central Processing Unit), DSP (Digital Signal Processor) or any other electronic programmable logic device. The controller 200 has associated electronic memory 202 such as RAM memory, ROM memory, EEPROM memory, flash memory, or any combination thereof. The memory 202 is used for various purposes by the controller 200, one of them being for storing data and program instructions for various software in the mobile terminal.

The software includes a real-time operating system 220, man-machine interface (MMI) drivers 234, an application handler 232 as well as various applications. The MMI drivers 234 cooperate with conventional MMI or input/output (I/O) devices, including a display 236 and a keyboard 238 as well as various other I/O devices such as a microphone, a speaker, a vibrator, a joystick, a ringtone generator, an LED indicator, etc. As is commonly known, the user 1 may operate the mobile terminal through the man-machine interface thus formed.

The applications include a control panel application 240, a contacts (phonebook) application 250, a call handling application 260 for voice calls and optionally circuit-switched data calls and/or fax transmissions, a messaging application 270 for SMS, MMS and/or email, and a web/wap browser 280. Applications 260-280 thus execute different telecommunication services 262, 272 and 282, respectively, in cooperation with the mobile telecommunications network 110.

Various other applications which are not explicitly shown in FIG. 2 may be present, such as a calendar application, a word processing or notebook application, a calculator, an electronic game, etc.

The software also includes various modules, protocol stacks, drivers, etc., which are commonly designated as 230 and which provide communication services (such as transport, network and connectivity) for a wireless RF interface 206, and optionally a Bluetooth interface 208 and an IrDA interface 210. The RF interface 206 comprises an internal or external antenna as well as appropriate radio circuitry for establishing and maintaining a wireless link to a base station of a mobile telecommunications network (e.g. link 102, base station 104 and network 110 in FIG. 1). As is well known to a man skilled in the art, the radio circuitry comprises a series of analogue and digital electronic components, together forming a radio receiver and transmitter. These components include, inter alia, band pass filters, amplifiers, mixers, local oscillators, low pass filters, AD/DA converters, etc.

The mobile terminal also has a SIM card 204 and an associated reader. As is commonly known, the SIM card 204 comprises a local processor 205 as well as local work and data memory 206.

Service availability update functionality 290 is also included in the mobile terminal. It is illustrated in FIG. 2 as a separate software application, but in other embodiments it may be integrated with the telecommunication service applications 260-280, or with lower layers of the terminal's software structure, such as the application handler 232, MMI 234 or real-time operating system 220.

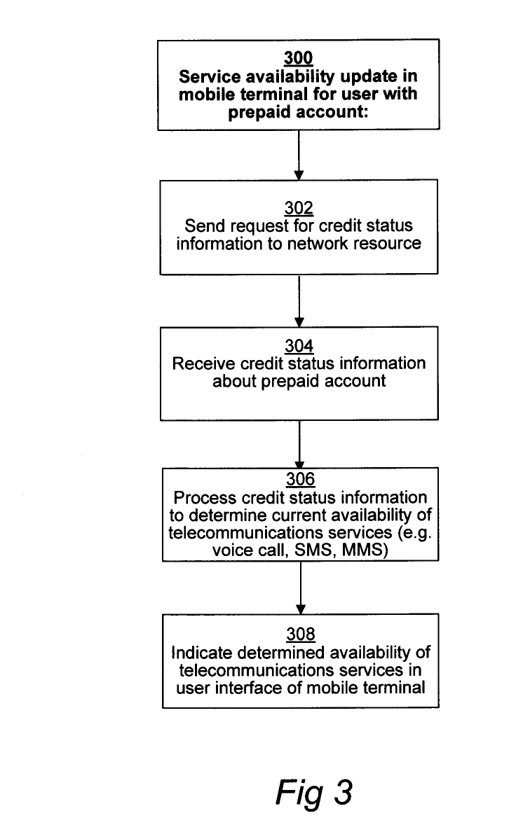

With reference to FIG. 3, one embodiment of a method 300 performed by the service availability update functionality 290 will now be described. This embodiment operates in a pull manner, and therefore the method 300 starts with a step 302 where the request 10 for credit status information is sent from the mobile terminal 100 to the network resource 112 over the mobile telecommunications network 110. Any available channel may be used depending on implementation, as has already been explained. In other embodiments which instead operate in a push manner, the step 302 can be omitted. The sending of the request 10 is triggered by a service availability update scheme which has been configured in the mobile terminal, or if the user 1 manually requests service availability update by entering the separate application 290 or invoking a command to this effect in any of the telecommunication service applications 260-280.

The disclosed embodiment uses a service availability update scheme which specifies service availability update each time the mobile terminal is powered on and/or at system access. However, as previously explained, in other embodiments the scheme may define a time-based periodicity, and/or that service availability update be performed after each completion of a telecommunication service (i.e., after completion of each voice call, transmission of each SMS message, etc).

The request 10 includes data by which the prepaid account 30 of the user 1 can be identified, such as relevant data from the user's SIM card 204.

Upon receipt of the request 10, or triggered by other parameters such as a timer in push-based embodiments, the network resource retrieves a prepaid account record in the account data base 114, reads the current balance and creates the credit status information 20 by including the current balance 22 therein. In addition, in the disclosed embodiment, the network resource includes service price data 24 in the credit status information 20.

The service price data 24 includes a list of applicable charges per relevant usage unit for different telecommunication services. In one example, the service price data may look like:

| Service | Startup | Rate | |
|---|---|---|---|
| Local voice call, home operator | 2 c.u. | 1 | c.u./min |
| Local voice call, other operator | 3 c.u. | 1.5 | c.u./min |
| Nat. voice call, home operator | 3 c.u. | 2 | c.u./min |
| Nat. voice call, other operator | 4 c.u. | 3 | c.u./min |
| Intern. voice call, country 1 | 10 c.u. | 5 | c.u./min |
| Intern. voice call, country 2 | 10 c.u. | 7 | c.u./min |
| Intern. voice call, country n | 10 c.u. | 8 | c.u./min |
| SMS, home operator | — | 1 | c.u. |
| SMS, other operator | — | 1.5 | c.u. |
| MMS, home operator | — | 10 | c.u. |
| MMS, other operator | — | 10 | c.u. |
| Packet data | — | 0.1 | c.u./kB |

| | | |
|---|---|---|
| . . . | . . . | . . . |

where c.u. = some Currency Unit.

In other embodiments, as explained in a previous section of this document, service price data may have been stored in advance in local memory of the mobile terminal 100 (either in the terminal memory 202, as seen at 224a, or in the SIM card memory 206, as seen at 224b).

The thus created credit status information 20 is sent by the network resource 112 to the mobile terminal 100 over an available channel, which may or may not be the same channel as the request 10 was received over.

In step 304, the mobile terminal 100 receives the credit status information 20. In step 306, the received credit status information is processed to determine the current availability of different telecommunication services for the prepaid account user, given his current account balance. To this end, in the disclosed embodiment, the mobile terminal derives the current balance 22 together with the service price data 24 from the received credit status information 20 and determines to what extent different telecommunication services are currently available for the prepaid account user 1, given the current balance 22 of his account 30 and a usage cost derived from the service price data 24 (224a, 224b).

The thus determined availability of telecommunication services is indicated to the user 1 in the user interface of the mobile terminal 100 in step 308. As already explained, this can be made in many different ways and at different levels of detail. In one embodiment, continuing with the exemplifying service price data 24 above, the indication may be an informative text like in the following examples:

### EXAMPLE 1

“Current balance: 57 c.u.
All services available”

### EXAMPLE 2

“Current balance: 9 c.u.
International calls unavailable”

### EXAMPLE 3

“Current balance: 9 c.u.
Local voice calls available (4/3)
National voice calls available (3/2)
SMS available (9/6)
Packet data available (90 kB)
-------------
MMS unavailable
International calls unavailable”

In this example, the user 1 is thus given a lot of useful information that provides him with a clear overview of his possible extent of service usage, given his current account balance. For instance, the user 1 will learn that he can either make up to 4 local calls via his home operator, or up to 3 local calls to other operators, assuming that such local calls are shorter than one minute and therefore only incur the startup cost. Alternatively, he can make up to 3 and 2 national calls, respectively, or send 9 SMS messages via his home operator or 6 via other operators, or use 90 KB of packet data. He cannot currently afford any MMS messages, and nor can he make any international calls.

### EXAMPLE 4

“Current balance: 0 c.u.
No services available”

Of course, in different embodiments, both the way in which such service availability update is presented, and into what detail it is made, may vary widely, as is understood by a skilled person.

The determined current availability of different telecommunication services may be used further in different ways. For instance, in the above Examples 2-4 where international calls are unavailable, the call handling application 260 may prevent an outgoing call to an international number already when the user attempts to make the call. Correspondingly, the contacts application may disable calls to all international numbers in the various contact records therein. Likewise, when the current balance only permits voice calls to the home operator (network operator 2), telephone numbers to subscribers of other operators may be blocked in the call handling and contacts applications.

Alternatively, appropriate warning messages may be given in the user interface of the mobile terminal 100, if the user attempts to use a service which, according to the most recent service availability update, his current balance cannot afford.

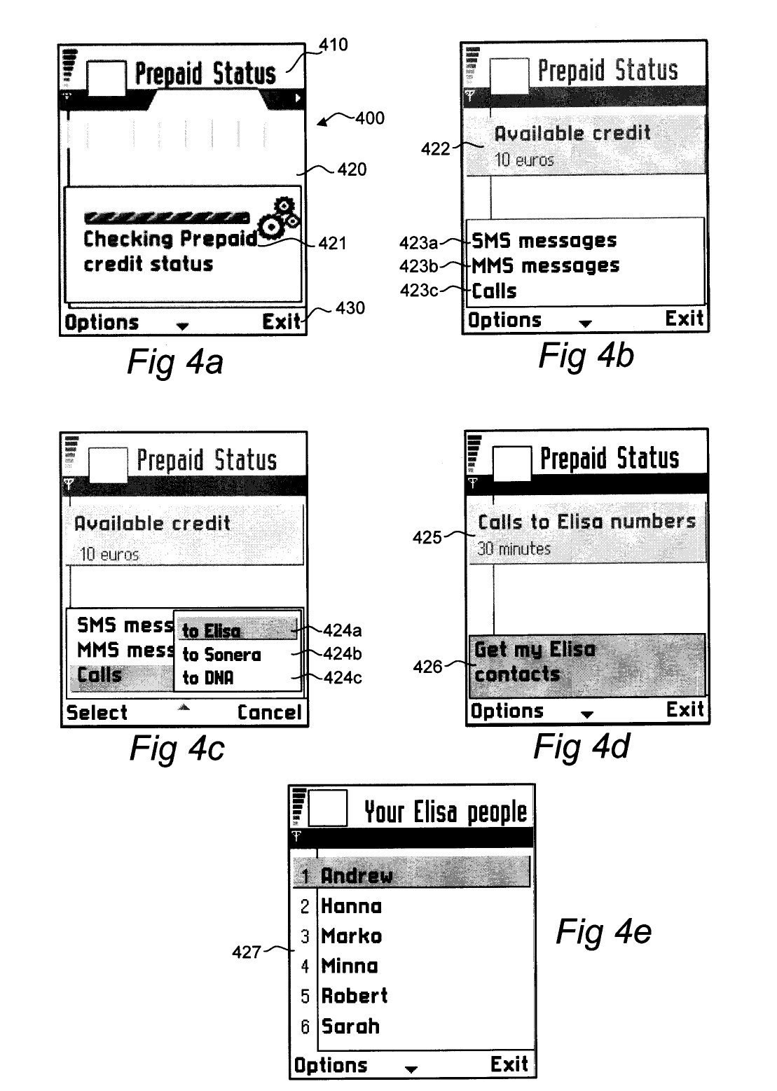

A use case will now be described with reference to the display screen snapshots of FIGS. 4a-4e, which are shown in sequence to the user 1 of the mobile terminal 100 when using one embodiment of the method according to the invention.

Starting with FIG. 4a, the display screen 400 of the mobile terminal 100 contains at its upper part a status area 410 which may contain various visual indications (text characters and/or graphical symbols), such as an antenna/received signal strength indicator, the current network operator, a battery level indicator, the current date/time, and a text header.

The center of the display screen 400 contains a main presentation area 420 which in FIG. 4a shows a feedback 421 to the user 1, in the form of a text and a progress bar.

Soft key labels 430 are provided at a lower part of the display screen 400.

The display screen 400 of FIG. 4a may be shown for steps 302 and 304 of FIG. 3.

In FIG. 4b, once the credit status information received in step 304 has been processed in step 306 and the execution enters step 308, the display screen 400 shows the derived current balance as 10 Euros at 422, as well as the determined service availability in the form of a popup menu list with three menu items 423a-423c, one for each different service category SMS messages, MMS messages, and Calls.

In FIG. 4c, upon selection of one menu item 423c, Calls, the display screen 400 shows different operators, including the home operator Elisa, as respective sub menu items 424a-424c. Upon selection, by way of a soft key, of the home operator Elisa, the display screen 400 is updated in FIG. 4d to present, at 425, an estimated remaining calling time (30 minutes) for calls to the home operator.

Simultaneously, at 426, the user 1 is offered to invoke further functionality in the form of a list 427 (FIG. 4e) of all Contact records in the contacts application 250 which are subscribers of the operator Elisa. This list may be used to conveniently place calls to any such contact.

In the example screenshots of FIGS. 4a-4e, all services were available (since the current balance 422 was large enough). However, when a certain service is no longer available because of a shortage of the current prepaid account balance, this fact can be indicated by disabling the corresponding menu item 423a-c/424a-c, thereby preventing selection thereof. Alternatively, the menu item can be left selectable, but a help/warning text can be given should the user 1 select it.

The invention has mainly been described above with reference to a few embodiments. However, as is readily appreciated by a person skilled in the art, other embodiments than the ones disclosed above are equally possible within the scope of the invention, as defined by the appended patent claims.

What we claim is:

1. A method of operating an apparatus enabled for usage by a user having a prepaid account at a service provider capable of providing one or more services over a communications network, the method comprising:
retrieving credit status information about the prepaid account;
at least for one service provided by said service provider, processing said credit status information to determine a current availability of said one service; and
controlling a user interface of said apparatus to indicate the determined availability of said one service.

2. The method as defined in claim 1, wherein the credit status information about the prepaid account is retrieved by receiving it from a network resource of said service provider over said communications network.

3. The method as defined in claim 1, wherein controlling the user interface involves presenting the determined availability of said one service on a display of the apparatus.

4. The method as defined in claim 3,
wherein said credit status information includes a current balance of said account,
wherein processing said credit status information involves determining whether the current balance is at least equal to a lowest cost for using said one service, and
wherein controlling the user interface involves presenting said one service as available, if the current balance has been determined to be at least equal to said lowest cost, and, otherwise, refraining from presenting said one service as available.

5. The method as defined in claim 4, wherein presenting said one service as available involves presenting a user interface item on said display as currently selectable, and wherein refraining from presenting said one service as available involves presenting said user interface item on said display as currently non-selectable.

6. The method as defined in claim 4, wherein said lowest cost for using said one service is derived from service price data received from a network resource of said service provider over said communications network.

7. The method as defined in claim 4, wherein said lowest cost for using said one service is derived from service price data stored in local memory in or associated with said apparatus.

8. The method as defined in claim 3,
wherein said credit status information includes a current balance of said account, and
wherein processing said credit status information involves determining, based on said current balance and a usage cost for using said one service, an extent of available usage for said one service, and
wherein controlling the user interface involves presenting the extent of available usage for said one service.

9. The method as defined in claim 2, involving an initial step, prior to receiving credit status information, of sending a request for credit status information from said apparatus to said network resource.

10. The method as defined in claim 9, wherein said initial step followed by the subsequent steps of the method are performed repeatedly in accordance with a predefined service availability update scheme.

11. The method as defined in claim 1, performed for said apparatus being selected from the group consisting of a mobile terminal, a personal digital assistant (PDA), a digital music player, a digital video player, a gaming device, a digital television receiver, a navigating device, and a computer.

12. The method as defined in claim 1, performed for said apparatus in the form of a mobile terminal, said service provider being an operator of a mobile telecommunications network, said one or more services being one or more telecommunication services to be performed over said mobile telecommunications network.

13. The method as defined in claim 12, wherein processing said credit status information involves determining a current availability of a first telecommunication service and a current availability of a second telecommunication service provided by said mobile telecommunications network operator, and wherein controlling the user interface of said apparatus involves indicating the determined availability of at least one of said first and second telecommunication services.

14. The method as defined in claim 13, wherein the first telecommunication service and the second telecommunication service are different services in the group consisting of: SMS messages, MMS message, email messages, voice calls, local voice calls, national voice calls, international voice calls, voice calls to subscribers belonging to the operator of said mobile telecommunications network, voice calls to subscribers belonging to another operator than said operator, data calls, fax transmissions, and packet-switched data communication.

15. The method as defined in claim 1,
wherein said credit status information includes a current balance of said account,
wherein processing said credit status information involves determining whether the current balance at least meets a threshold cost value, and
wherein, if the current balance has been determined not to meet said threshold cost value, controlling the user interface involves:
prompting the user to input purchasing details, and
transmitting the purchasing details thus input to a network resource of said service provider so as to request purchase of additional credit.

16. An apparatus enabled for usage by a user having a prepaid account at a service provider capable of providing one or more services over a communications network, the apparatus comprising:
a processing device; and
a user interface,
wherein the processing device is configured to:
retrieve credit status information about the prepaid account; at least for one service provided by said service provider, process said credit status information to determine a current availability of said one service; and
control the user interface to indicate the determined availability of said one service.

17. The apparatus as defined in claim 16, further comprising a network interface adapted for communication with said communications network, wherein the processing device is configured to retrieve the credit status information about the prepaid account by receiving it from a network resource of said service provider via said network interface.

18. The apparatus as defined in claim 16, said user interface including a display of said apparatus, wherein the processing device is configured to control the user interface to present the determined availability of said one service on said display.

19. The apparatus as defined in claim 18,
wherein said credit status information includes a current balance of said account,
wherein the processing device is configured to process said credit status information by determining whether the current balance is at least equal to a lowest cost for using said one service, and
wherein the processing device is configured to control the user interface to present said one service as available, if the current balance has been determined to be at least equal to said lowest cost, and, otherwise, to refrain from presenting said one service as available.

20. The apparatus as defined in claim 19, wherein the processing device is configured to present said one service as available by presenting a user interface item on said display as currently selectable, and wherein the processing device is configured to refrain from presenting said one service as available by presenting said user interface item on said display as currently non-selectable.

21. The apparatus as defined in claim 19, wherein the processing device is configured to derive said lowest cost for using said one service from service price data received from said network resource.

22. The apparatus as defined in claim 19, wherein the processing device is configured to derive said lowest cost for using said one service from service price data stored in local memory in or associated with said apparatus.

23. The apparatus as defined in claim 18,
wherein said credit status information includes a current balance of said account,
wherein the processing device is configured to process said credit status information by determining, based on said current balance and a usage cost for using said one, an extent of available usage for said one service, and
wherein the processing device is configured to control the user interface to present the extent of available usage for said one service.

24. The apparatus as defined in claim 17, wherein the processing device is configured, prior to receiving credit status information, to send a request for credit status information from said apparatus via said network interface to said network resource.

25. The apparatus as defined in claim 24, wherein the processing device is configured to operate in accordance with a predefined service availability update scheme to repeatedly send said request for credit status information, receive said credit status information, process said credit status information, and control said user interface to indicate the determined availability of said one service.

26. The apparatus as defined in claim 16, said apparatus being selected from the group consisting of a mobile terminal, a personal digital assistant (PDA), a digital music player, a digital video player, a gaming device, a digital television receiver, a navigating device, and a computer.

27. The apparatus as defined in claim 16, said apparatus being a mobile terminal, said service provider being an operator of a mobile telecommunications network, and said one or more services being one or more telecommunication services to be performed over said mobile telecommunications network.

28. The apparatus as defined in claim 27, wherein the processing device is configured to process said credit status information by determining a current availability of a first telecommunication service and a current availability of a second telecommunication service provided by said mobile telecommunications network operator, and wherein the processing device is configured to control the user interface of said apparatus to indicate the determined availability of at least one of said first and second telecommunication services.

29. The apparatus as defined in claim 28, wherein the first telecommunication service and the second telecommunication service are different services in the group consisting of: SMS messages, MMS message, email messages, voice calls, local voice calls, national voice calls, international voice calls, voice calls to subscribers belonging to the operator of said mobile telecommunications network, voice calls to subscribers belonging to another operator than said operator, data calls, fax transmissions, and packet-switched data communication.

30. The apparatus as defined in claim 16, further comprising a network interface adapted for communication with said communications network, said credit status information including a current balance of said account,
wherein the processing device is configured to process said credit status information by determining whether the current balance at least meets a threshold cost value, and
wherein, if the current balance has been determined not to meet said threshold cost value, the processing device is configured to control the user interface to:
prompt the user to input purchasing details, and
transmit the purchasing details thus input via said network interface to a network resource of said service provider so as to request purchase of additional credit.

31. A system comprising:
a network resource of a service provider capable of providing one or more services over a communications network; and
an apparatus enabled for usage by a user having a prepaid account at said service provider, the apparatus comprising a processing device and a user interface, wherein the processing device is configured to:
receive credit status information about the prepaid account from said network resource;
at least for one service provided by said service provider, process said credit status information to determine a current availability of said one service, and
control the user interface to indicate the determined availability of said one service.

32. An apparatus enabled for usage by a user having a prepaid account at a service provider capable of providing one or more services over a communications network, the apparatus comprising:
means for retrieving credit status information about the prepaid account;
means for processing said credit status information to determine a current availability of at least one service provided by said service provider; and
means for controlling a user interface to indicate the determined availability of said one service.

33. A computer program product comprising machine-readable instructions which, when executed by a processing device, perform the steps of the method defined in claim 1.
